(19) United States
(12) Patent Application Publication
(10) Pub. No.: US 2015/0081100 A1
(43) Pub. Date: Mar. 19, 2015

(54) METHOD FOR CALIBRATING KINEMATICS

(71) Applicant: Johannes Gottlieb, Bellheim (DE)

(72) Inventor: Johannes Gottlieb, Bellheim (DE)

(21) Appl. No.: 14/235,201

(22) PCT Filed: Jul. 19, 2012
(86) PCT No.: PCT/EP2012/064162

§ 371 Date: May 12, 2014

(30) Foreign Application Priority Data
Jul. 25, 2011 (DE) 102011079764.5

(51) Int. Cl. B25J 9/16

(52) U.S. Cl. CPC B25J 9/1664
USPC 700/262

(57) ABSTRACT

The invention relates to a method for calibrating parallel and serial robot kinematics, which have not been constructed especially for achieving the greatest possible accuracies. To this end, there is proposed a method which includes the following steps: —moving the kinematics along a predetermined number of first configuration vectors, wherein a control function is applied to the configuration vectors,—measuring the pose of the kinematics that is taken up as a result of the movement,—determining second configuration vectors which lead to the measured pose by application of the control function,—determining a correction value for at least a part of the first configuration vectors by evaluating the part of the first and associated second configuration vectors,—determining a function for transforming the configuration space by evaluating the correction values, and—defining a calibrated control function from sequentially carrying out first the function for transforming the configuration space and subsequently the control function.

### INTRODUCTION

The invention relates to a method and an arrangement for calibrating kinematics as well as to a corresponding computer program and a corresponding computer-readable storage medium, which can be used in particular to expand a calibration to classes of parallel and serial robot kinematics, which have not been specifically designed to achieve utmost precision. The key terms are defined below.

Manufacturer information concerning the positioning accuracy of robot kinematics relate to general error estimates as well as to measurements of positioning deviations in various poses.

In many robot kinematics, it has so far been impractical to reliably state error measures (e.g. standard deviation). These error measures would have to apply to all feasible poses. Such error estimates are possible in the special case of coordinate measuring machines; however, these machines are designed with error estimates in mind.

Because it has so far been practically impossible in many kinematics to determine the positioning accuracy in the entire workspace and to validate the data, these data do not mention definitive error limits that reliably state error measures. Accuracy information, that is common in the special case of coordinate measuring machines, would be desirable. Coordinate measuring machines are of course also designed so as to enable such error estimates.

The proposed novel method measures the positioning error at points that are generated based on a “map” of the configuration space. Since the configuration space has a particularly simple form, usually a cuboid shape, a uniform distribution of test points can be easily realized in this space. A uniform distribution of test points in the configuration space also entails a uniform distribution in the workspace. This is the result of constructive and functional requirements in the design of kinematics where it is assumed that a small change in the pose is caused by a small change in the configuration space and, on the other hand, a small change in the configuration space entails only a small change in the work space.

A large number of poses is obtained, wherein the error in the pose is completely eliminated, except for negligible residual errors, as a result of compensation according to the present method. Reliable error estimates can be obtained for the remaining points of the work space by using error estimates based on expected deviations of the geometry parameters. The novel method is hence suited, in contrast to the parameter identification, to have the pose errors confirmed by an accredited, government agency.

The use of kinematics systems that are provided with a “verification certificate” attesting to their accuracy and that have in addition an increased precision due to the pose error compensation and that have clearly limited poses errors, opens completely new fields of application particularly in robotics, such as in medical technology, micro-and nanotechnology.

The presented method of transforming the configuration space can not only be used with active kinematics (robot), but also with kinematics configured to measure poses, such as coordinate measuring machines. Their accuracy is also enhanced by applying the presented method of transforming the configuration space.

State of the Art

A number of approaches for calibrating kinematics exist. Many calibration methods—also the method presented here—can be used with serial as well as parallel kinematics for robots and manipulators, as well as with measuring devices such as coordinate measuring machines or machine tools. The methods for pose error compensation of kinematics refer first to the kinematics itself, but frequently also include peripheral elements such as end effectors, various attachments and adapters. According to the prior art, the calibration is based mostly on obtaining a correct kinematics model of the individual to be calibrated by way of parameter identification, in order to thereby compensate for the effect of differing geometry parameters.

The pose of kinematics as a function of an element of the configuration space is defined by a plurality of geometry parameters which is referred to as the “kinematics model” of this kinematics.

In particular, because of technical production-induced tolerance variations and limited tolerance dimensions in production, every individual of the same type shows deviations in its geometry parameters compared to the geometry parameters of its kinematics model specified by the design.

As a result, only a control of kinematics based on a nominal kinematics model causes pose errors. Because such pose errors cannot be neglected in many applications, calibration measures are required.

Since deviations in the geometry parameters are responsible for the majority of the pose errors, measures for the pose error compensation are in practice almost exclusively based on the most precise identification of the geometry parameters (“parameter identification”) for each individual.

This identification process is based on the comparison of a plurality of theoretically calculated poses of the kinematics with those poses that have been determined by precision measurements, starting from the same element of the configuration space. Extensive literature exists on this topic, which deals also generally with the topic of robotic pose error compensation. An example to be mentioned here would be:

Roth, Z. S.; Mooring, B. W.; Ravani, B.: An Overview of Robot Calibration. IEEE J. Robotics and Automation Vol. RA-5 No. 5, 1987, pages 377-385,

Mooring, B. W ; Roth, Z. S.; Driel, M. R.: “Fundamentals of Manipulator Calibration”, John Wiley & Sons, 1991,

R. Bernhardt and S. Albright, Robot Calibration, Eds. (Chapman & Hall, London, 1993) or

Lukas Beyer: Accuracy Improvement of Industrial Robots, particularly with Parallel Kinematics. Dissertation, Helmut-Schmidt-University Hamburg. Shaker Verlag, Aachen 2005, ISBN 3-8322-3681-3.

The pose error compensation based on parameter identification has a number of disadvantages. In fact, the parameter identification in the present class of problems has serious problems relating to the identification of the determined parameters (non-convexity of the error functions, i.e. ambiguity, numerical instabilities, etc.). The determined parameters replace the constructive geometry parameters of the elaborately constructed kinematics model and diminish hereby the precision in the production and installation of the components of the kinematics.

Additional significant difficulties and uncertainties arise in the numerical determination of the geometry parameters from the measured data. The employed algorithms are heuristic (e.g. downhill-simplex), the reliability of the results is subject to considerable uncertainties, and the accuracy of the results must therefore in principle be questioned. Accordingly, very small deviations in the measured values can cause large deviations in the determined parameters. For example, random errors in the pose determination in individual measured poses affect the determined parameters in an unpredictable way. It is therefore not surprising that the state of the art is unsatisfactory and intensive research is being conducted in the field of compensation of pose errors.

It was therefore an object of the invention to provide a method and an arrangement for calibrating kinematics as well as a corresponding computer program and a corresponding computer-readable storage medium, which obviates the aforedescribed disadvantages and more particularly allows determining reliable error measures for a variety of parallel and serial robot kinematics.

This object is solved according to the invention by the features recited in claims 1 and 7 to 10. Advantageous embodiments of the invention are recited in the dependent claims.

According to a particular advantage of the invention, kinematics for all feasible poses can be corrected with high precision. This is achieved by specifying in the method for the calibration of kinematics according to the invention a plurality of defined actuator positions. The actuator positions are defined by configuration vectors. First vectors x of the configuration space KR correspond to the actuator positions, wherein the first vectors x are mapped by a control function, also referred to as direct kinematics DK, onto a pose p (x) in the pose space PR or more precisely: in the work space AR. The kinematics for poses is moved by applying the control function. In general, the pose assumed by the kinematics when the control function is applied to a first vector x differs from the theoretically calculated pose p(x). Therefore, the poses are measured, in relation to which the kinematics moved when the control function is applied to the specified number of defined actuator positions. The obtained values are referred to as direct kinematics GDK (x) measured for the first vector x.

Each control function DK is associated with an inverse mapping, the so-called inverse kinematics IK. By using the inverse kinematics IK, the particular actuator position x that results in the pose p when the control function is applied to the vector x is determined for each pose p. This inverse kinematics IK is now applied to the measured poses gDK(x). A second vector x′=IK(gDK (x)) of the configuration space KR is thereby calculated which is generally different from the predefined first vector x.

A corresponding correction value for at least a discrete subset (sample set) of first vectors x of the configuration space KR is determined by evaluating the first and the associated second vectors, respectively. Preferably, the correction value is a vectorial correction value. When the first vector and the associated correction values on the discrete subset of configuration space are known, the set of the correction values is expanded to additional, preferably to all elements of the entire configuration space, preferably by interpolation and extrapolation. A third vector from the configuration space can now be associated with these vectors from the configuration space by applying the respective correction value. The mapping of first onto third vectors may be viewed as a transformation of the configuration space.

A calibrated control function is defined by using the function for transforming the configuration space, such that first the function for transforming the configuration space onto a vector x from the configuration space is applied, whereafter the control function is applied to the thus obtained transformed vector from the configuration space. Stated more precisely: When a pose p to be assumed, the vector x=IK(p) from the configuration space, which would theoretically result in the pose p, is determined via the inverse kinematics IK. The transformation is applied to this vector x to obtain a corrected vector. The mapping of this transformation, i.e. the value obtained by performing this transformation, is also a vector which is typically an element of the configuration space. When this value is an element of the configuration space, this value is applied the direct kinematics DK. Otherwise, an unrealizable pose would be obtained. The calibrated control function is therefore the successive execution of the function for transforming the configuration space and of the (original) control function on the vector x. The calibrated control function instead of the (original) control function is now used for controlling, moving or commanding the kinematics.

According to a preferred embodiment of the invention, the actuator positions defined by the subset of first vectors x of the configuration space KR may largely be uniformly distributed in the configuration space. When an actuator operates, for example, in an interval [a, b] (which may be, for example, a translatory or rotatory interval), the interval is in accordance with this preferred embodiment uniformly divided into n equal sub-intervals. The boundaries of these sub-intervals are then used as predetermined components of first configuration vectors x of the configuration space KR. This generates a uniformly distributed grid of points in the configuration space KR. According to the invention, a respective correction value is assigned to each of these points, and the function for transforming the configuration space, which assigns to each point or vector x of the configuration space KR a correction value, is determined from this association for the discretely distributed points in the configuration space KR by interpolation or extrapolation. In a preferred embodiment, this function obtained by interpolation or extrapolation is continued to values of the configuration space that extend beyond the intervals realizable with the kinematics.

Since when measuring the poses assumed by the kinematics even those poses can be determined, which cannot be theoretically reached by applying the control function to vectors from the range of values of the actuator intervals, a difference results between the work space, i.e. the set of the poses realizable with the kinematics when evaluating the control function, and the poses actually assumed with the kinematics. According to a preferred embodiment, this difference is taken into account in the definition of the calibrated control function.

According to another preferred embodiment of the invention, a correction of a pose may be obtained with the method for pose error compensation of kinematics by using a corrective transformation of the configuration space. The corrective transformation of the configuration space is characterized in that, starting from a finite subset of the configuration space, a vectorial correction summand is determined for each element x of this set and the thereby defined function is expanded to the entire configuration space by an appropriate expansion of the definition range, and the corrective transformation for the entire configuration space is generated by adding the correction summands obtained by way of the expanded function, to the identical self-mapping of the configuration space onto itself. The corrected pose P of a kinematics individual is realized by first obtaining from the desired pose p by applying the inverse kinematics IK an element of the configuration space, by adding to this element a correction value associated with this element, and by thereafter commanding the pose. The pose correction is thus characterized in that a corrective inverse kinematics is executed for realizing the pose.

According to a preferred embodiment, the sample set of a cuboid configuration space is used as predetermined first configuration vectors (sample set) of the configuration space, and the corrected inverse kinematics of the cuboid configuration space is used as the corrected inverse kinematics. A cuboid configuration space refers to the Cartesian product of all workspaces or actuator intervals [a(i), b(i)] (i=1, . . . , DOF). A cuboid element is to be understood as a multidimensional rectangular solid.

Advantageously, the actuator intervals [a (i), b (i)] (i=1, . . . , DOF) may be subdivided into further sub-intervals. Advantageously, the actuator intervals may be subdivided into sub-intervals of equal length. The interval boundaries W(j, i) with a(i)=W(0, i)<W(1, i) <W (3, i) . . . <W(Q(i), i)=b(i) are also referred to as interval segmentation scalars. According to a preferred embodiment, the interval segmentation scalars of the actuator intervals do not include at least some of the endpoints of the actuator excursions, such that the cuboid included on the configuration space is a proper subset of the configuration space. It is provided that the corrected inverse kinematics of the cuboid configuration space is applied of the corrected inverse kinematics. The correction function is obtained through extrapolation in the difference set “configuration space \ cuboid.”

According to another preferred embodiment, the configuration space may be covered in its entirety or partially with finite elements. The corners of the finite elements are here measured as sample set.

According to another preferred embodiment, n-simplices are used as finite elements. The dimension n hereby corresponds to the degree of freedom DOF of the kinematics. Correction values for this sample set are determined, as described above, based on the sample set defined by the edges of the simplices. These are then barycentrically interpolated in the interior of the individual simplexes or extrapolated outwardly. A transformation of the configuration space is defined, as described above, based on these correction values, on which, as described above, the corrective inverse kinematics is based.

The aforementioned methods may be performed sequentially several times and/or combined with one another. Additional corrections based on error mapping and compensation calculations can be performed in some areas or points of the configuration space, of the work space, or of both spaces.

An arrangement according to the invention has at least one chip and/or processor, and is configured to execute a method for calibrating kinematics, wherein the method includes the following steps:
Moving the kinematics according to a predetermined number of first configuration vectors, wherein a control function is applied to the configuration vectors,
Measuring the pose of the kinematics assumed as a result of the movement,
Identifying second configuration vectors that lead to the measured pose through application of the control function,
Determining a correction value for at least part of the first configuration vectors by evaluating the part of the first and of the associated second configuration vectors,
Determining a function for transforming the configuration space by evaluating the correction values, and
Defining a calibrated control function by successively executing first the function for transforming the configuration space and thereafter the control function.

A computer program according to the invention enables a data processing device, after the computer program has been loaded into storage means of the data processing device, to perform a method for calibrating kinematics, wherein the method includes the following steps:
Moving the kinematics according to a predetermined number of first configuration vectors, wherein a control function is applied to the configuration vectors,
Measuring the pose of the kinematics assumed as a result of the movement,
Identifying second configuration vectors that lead to the measured pose through application of the control function,
Determining a correction value for at least part of the first configuration vectors by evaluating the part of the first and of the associated second configuration vectors,
Determining a function for transforming the configuration space by evaluating the correction values, and
Defining a calibrated control function by successively executing first the function for transforming the configuration space and thereafter the control function.

According to a further preferred embodiment of the invention, the computer program according to the invention may have a modular structure, wherein the individual modules may be installed on various parts of the data processing device.

Advantageous embodiments additionally provide computer programs configured to perform additional process steps or process flows specified in the written description.

Another aspect of the invention relates to computer-readable data which include at least parts of the calibrated control function determined by the method of the invention and/or at least part of the correction values determined by the method according to the invention.

Such computer programs and/or computer-readable data may be provided, for example (for a fee or free of charge, freely accessible or password-protected) for downloading in a data or communication network. The provided computer programs can then be utilized by a method wherein a computer program according to claim 8 and/or computer-readable data according to claim 9 are downloaded from an electronic data network, for example from the Internet, to a data processing device connected to the data network.

The method according to the invention may be carried out by using a computer-readable storage medium on which a program is stored which enables a data processing system, after the program has been loaded into storage means of the data processing device, to execute a method for calibrating kinematics, wherein the method includes the following steps:
Moving the kinematics according to a predetermined number of first configuration vectors, wherein a control function is applied to the configuration vectors,
Measuring the pose of the kinematics assumed as a result of the movement,
Identifying second configuration vectors that lead to the measured pose through application of the control function,
Determining a correction value for at least part of the first configuration vectors by evaluating the part of the first and of the associated second configuration vectors,
Determining a function for transforming the configuration space by evaluating the correction values, and
Defining a calibrated control function by successively executing first the function for transforming the configuration space and thereafter the control function.

Another aspect of the invention relates to a computer-readable storage medium on which data are stored, which include at least parts of the calibrated control function determined by the method of the invention and/or at least part of the correction values determined by the method according to the invention.

According to the invention, the calibration presented here will be extended to kinematics of coordinate measuring machines, and to all other kinematics that are themselves used for pose measurements. This kinematics may have completely or partially non-driven actuators which, however, permit a determination of an excursion. The results of the poses measurements made by this kinematics are calculated by determining the actuator excursions. The calibration includes the following steps:
Moving the kinematics according to a predetermined number of first configuration vectors, wherein a control function is applied to the configuration vectors,
Measuring the pose of the kinematics assumed as a result of the movement,

Identifying second configuration vectors that lead to the measured pose through application of the control function,
Determining a correction value for at least part of the first configuration vectors by evaluating the part of the first and of the associated second configuration vectors,
Determining a function for transforming the configuration space by evaluating the correction values.

The following steps are now performed in the pose measurements with these thereby calibrated calibration machines:
Moving the kinematics to a pose that is to be determined
Reading the excursion sensors of all actuators and thus determining an element of the configuration space
Applying the transformation of the configuration space, as described above, to the measured vectors of the configuration space in order to obtain corrected configuration vectors
Applying Direct Kinematics to the configuration vector corrected by the transformation, and thus determining the pose by taking advantage of the calibration
The invention will now be explained in detail with reference to examples of calibrating kinematics. It should be noted that the invention is not limited to the embodiments described below, but that the invention also includes other methods, devices, computer programs, or storage media, as long as these only implement all the features of the independent claims.

The exemplary embodiments will be described in more detail with reference to the appended drawings, which show in:

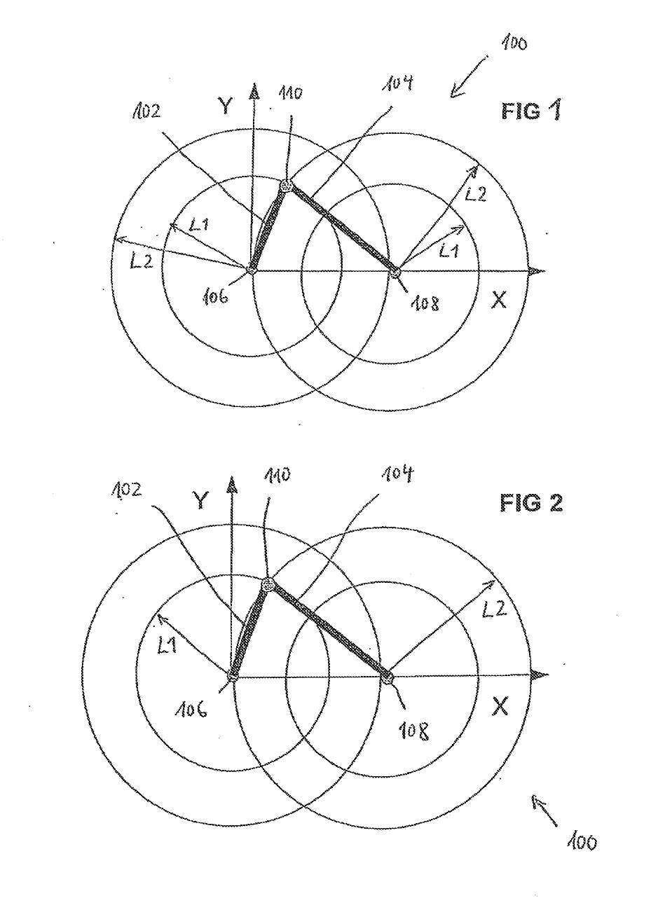

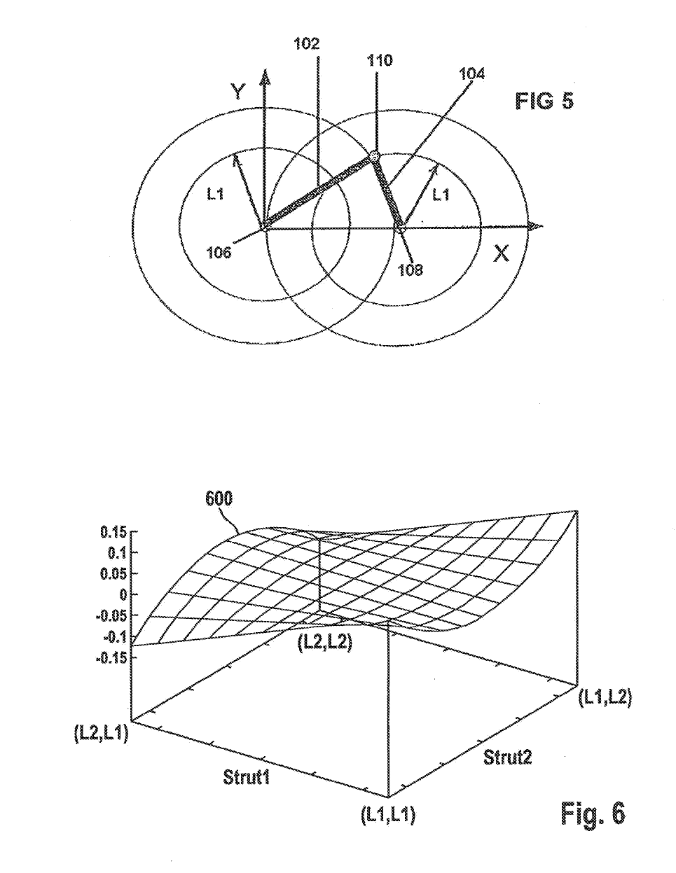

FIGS. 1 to 5 an illustration of the workspace of an exemplary kinematics with DOF=2,

FIG. 6 an illustration of an exemplary correction function for a first actuator of the exemplary kinematics,

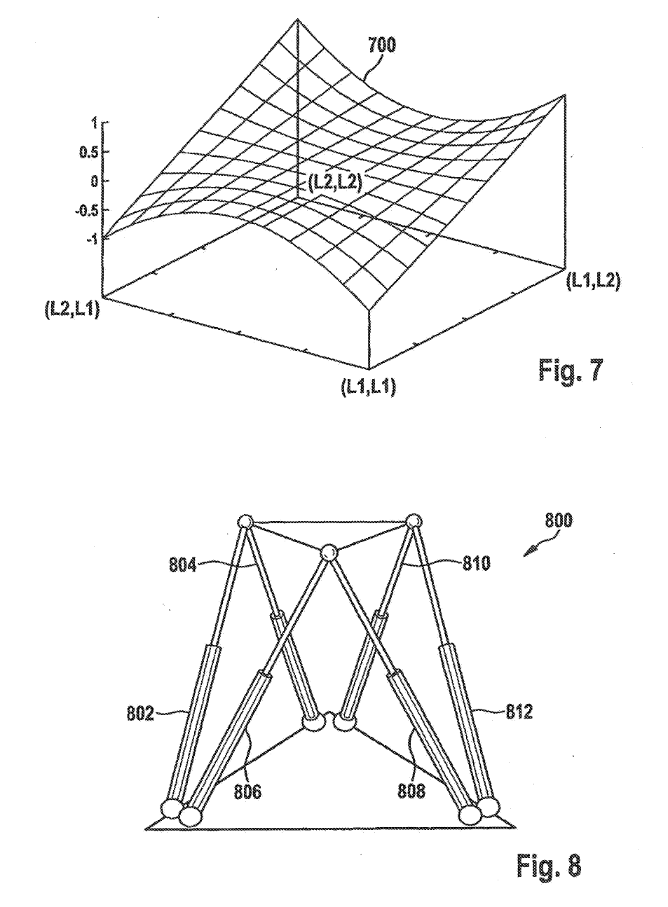

FIG. 7 an illustration of an exemplary correction function for the second actuator of the exemplary kinematics, and

FIG. 8 a diagram of kinematics constructed as a Stewart Gough platform.

The calibration procedure will now be explained in more detail with reference to FIGS. 1 to 7 in relation to an exemplary simple kinematics 100 with DOF=2.

The kinematics 100 illustrated in FIG. 1 consists of two variable-length struts 102, 104 (linear actuators), also referred to as struts. One end of each of the struts 102, 104 is affixed in a rotational joint 106, 108, with the other ends of the two struts 102, 104 being coupled together at a common pivot joint 110.

A pose assumed by the kinematics 100 in two dimensions is a location defined by the Cartesian coordinates x and y. It is known that this point is also well defined by the two strut lengths.

The radii of the circles in FIG. 1 represent the strut lengths L1 and L2 used in the specific embodiment. A total of four configurations can be generated with the values L1 and L2 for a four-element sample set (L1, L1), (L1, L2) (L2, L1) and (L2, L2). This sample set corresponds to the above-mentioned first configuration vectors.

These four poses of the sample set are shown in FIGS. 2-5, which result from the combination of the strut lengths L1 and L2 when both struts 102, 104 have the respective strut lengths L1 and/or L2.

In these 4 poses, the poses actually assumed by the kinematics 100 (in Cartesian coordinates) can be measured and calculated by using external measurement equipment (for example, a coordinate measuring machine).

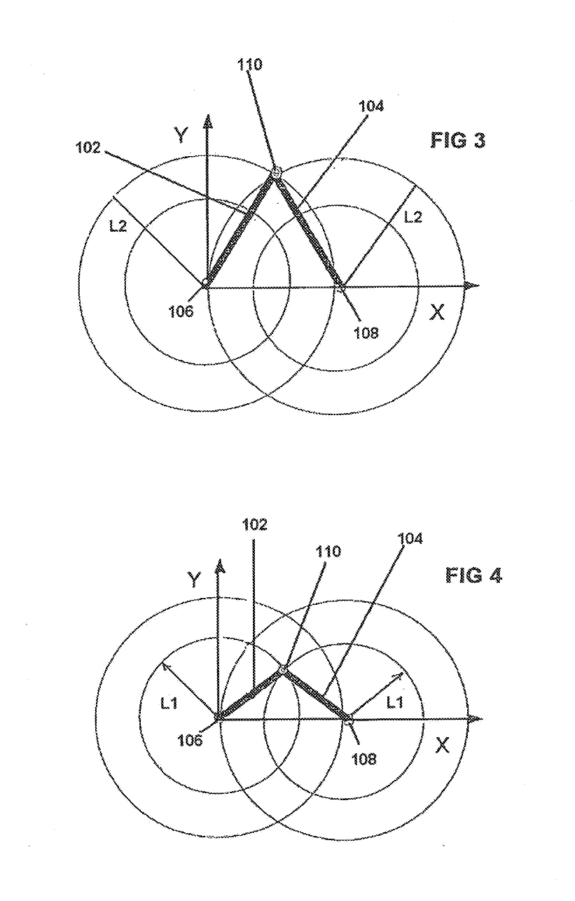

In FIG. 2, it will be assumed that, for example, a pose with values (x′, y′) different from the values (x, y) was measured. The second configuration vector (L1′, L2′) is calculated from these data (x′, y′) by using the inverse kinematics IK(x′, y′). A similar procedure is followed in FIGS. 3 to 5.

The two resulting correction summand functions can be found in FIG. 6 (for strut 102) and FIG. 7 (for strut 104).

This correction summand functions correspond to the correction summand function KSF_{—} PM on the sample set of the configuration space.

The correction summands at the locations (L1, L2), (L2, L2), (L1, L1) and (L2, L1) in FIGS. 6 and 7 are each associated with the poses of the FIGS. 2 to 5. Four function values in the diagrams of FIGS. 6 and 7 are thus based on measured pose deviations. All other points are obtained by interpolation.

The calibration is thus based on the correction functions 600, 700 for the first strut 102 and the second strut 104 shown in FIGS. 6 and 7.

When the pose (x, y) is to be realized with error compensation, the strut lengths S1 of the first strut 102 and S2 of the second strut 104 theoretically associated with the pose are calculated first. Correction summands ds1 for the first strut 102 and ds2 for the second strut 104 can be read by using these strut lengths from the diagrams of FIGS. 6 and 7. The functions illustrated in FIGS. 6 and 7 correspond to the correction summand function KSF_KR on the configuration space.

When now the strut lengths S1+ds1 and S2+ds2 are adjusted, the pose is correctly error-compensated at this point.

FIG. 8 illustrates kinematics 800 referred to as Gough Stewart platform. This kinematics has six struts 802, 804, 806, 808, 810 and 812. Although the kinematics 800 is much more complicated to describe and the situation is therefore confusing, the method described above for the simple example can likewise advantageously also be used with this kinematics, as has been impressively demonstrated by simulations.

The invention is not limited in its embodiment to the above-described preferred exemplary embodiment. Instead, a number of variations are possible, which makes use of the method according to the invention, the apparatus according to the invention, the computer program according to the invention and the computer-readable storage medium according to the invention even in fundamentally different embodiments.

### DEFINITIONS AND EXPLANATIONS

The exemplary embodiments will now be supplemented by some notes relating to the basic concepts of calibration:

Kinematics

The term kinematics refers to both the class of serial and parallel kinematics, and also combinations of the two classes. The classes include, for example, robots, machine tools, processing machines, manipulators, coordinate measuring machines, solid body robots. Furthermore, the classes also include kinematics provided with redundant sensors.

Actuator

In the present document, an actuator is defined as follows: An actuator is a technical device that converts an input value (electrical voltage, digital value, etc.) to a physically realized parameter or to a change in a physical parameter that represents a degree of freedom of the kinematics. The excursion of the actuators can be determined, for example, from a known relationship between excursion and input value or realized, for example, with special measuring devices.

Actuators are those technical components whose excursions represent the elements of the configuration space. In addition to mechanically acting actuators, actuators also include elements of the kinematics that only perform measurements.

In particular, the actuators include linear actuators, rotary tables and linear measuring devices and rotary measuring devices, actuators from memory alloys, piezoelectric ceramics, pneumatic or hydraulic implementations, etc.

Freedoms of the Kinematics (DOF, Degree Of Freedom)

DOF is defined as the number of degrees of freedom of the kinematics.

In the presented method, the number of the actuators in the kinematics suitable for the method is DOF. If redundancy exists, i.e. if the number of actuators exceeds the DOF, then DOF actuators are selected and taken into account in the calibration according to the invention.

Pose (P)

The pose of kinematics refers to the combination of position and orientation or components or subsets thereof of all moving rigid bodies relevant for the kinematics.

Usually, the pose is associated with a single rigid body. According to the invention, however, kinematics composed of several sub-kinematics can be calibrated with corresponding relevant rigid bodies.

Pose space (PR)

The pose space area is to be understood as either the set of all poses theoretically attainable with kinematics, or even a suitable superset of these poses, such as the special Euclidean group SE(3) for the Gough manipulator.

Configuration space (KR)

Kinematics is controlled by actuators. The respective excursions of the actuators 1, 2, 3, . . . , DOF can be expressed as a vector x. Within the context of this patent, the configuration space is thus that part of the R^{DOF} provided during the operation of the kinematics.

Direct Kinematics (DK)

A direct kinematics is a function that assigns the corresponding pose from the pose space to an element from the configuration space.

DK:KR→PR

This assignment is done in a theoretical manner and is based on the constructive geometry parameters of the kinematics. In practice, the reversible unambiguity is ensured, and without loss of generality a reversible unambiguous mapping is assumed here.

Usually, the Direct Kinematics is stored as a function in a control computer.

Work Space (AR)

The work space is the part of the pose space provided for the operation of the kinematics. It is the set of all poses that a robot is capable of assuming and should assume in normal operation.

Inverse Kinematics (IK)

An inverse kinematics is a function that assigns to each pose from the pose space the corresponding element from the configuration space. IK is the inverse mapping of DK.

IK:PR→KR

Measured Direct Kinematics (GDK)

The actually assumed pose in this configuration can be determined for each element from KR by a measurement—for example by using a coordinate measuring machine. The mapping of the elements of KR onto the actually assumed pose is referred to as measured direct kinematics (GDK).

GDK maps the configuration space onto the work space:

GDK:KR→AR

Sample Set of the Configuration Space (PM)

A set of elements from the configuration space that is provided for the calibration is selected as PM.

Correction Summand Function for PM (KSF PM)

A correction summand from R^{DOF}. is assigned to each element x ε PM:

KSF_PM:R^{DOF}→R^{DOF}, x→x−IK(GDK(x))

The summands have the opposite mathematical sign in kinematics used for measuring poses.

The correction summand x-IK(GDK(x)) thus represents the difference between a predetermined excursion x of the actuators (which would theoretically lead to the pose DK(x)) and the excursion IK(GDK(x)) of the actuators determined from the measured pose GDK(x) with the inverse kinematics.

Corrected Direct Kinematics PM (KDK PM)

A p εAR is assigned to each element x ε PM according to:

KDK_{—}PM(x)=DK(x+KSF_{—}PM(x)).

Correction Summand Function for KR (KSF KR)

KSF_PM is defined only on the sample set PM. KSF_KR designates a function having a definition range that covers the entire KR. Preferably, the value of a correction summand function is associated with each point on KR by interpolating or extrapolating the values of KSF_PM or by a suitable approximation of the values of KSF_PM.

### GLOSSARY

Gough Manipulator

Refers to a parallel manipulator with DOF=6 wherein a movable and a static part are interconnected by 6 variable-length legs. Gough manipulators are also known as hexapods.

Nₖ Nₖ={1, 2, 3 . . . k}, k ε N

DOF Degree of Freedom, degree of freedom of kinematics

i i ε N_{DOF}, i always labels the actuators

[a(i) b(i)] interval of the allowable excursions of the actuator i

Q(i) Q(i) is the number of interval divisions for the actuator i

Orientation indicates how a body is oriented in three-dimensional space. The set of orientations in three-dimensional space is referred to as special orthogonal group SO(3).

x an element of the configuration space, represented as a vector of the actuator excursions

p element of the pose space, represented by a vector

1-10. (canceled)

11. A method for calibrating a kinematics, the method comprising the steps of:
Defining a predetermined number of first configuration vectors of a configuration space,
Moving the kinematics by applying a control function to the first configuration vectors,
Measuring a pose of the kinematics assumed as a result of moving the kinematics,
Applying an inverse function of the control function to the measured pose for determining second configuration vectors,
Evaluating at least a subset of the first configuration vectors and of the second configuration vectors associated with the subset of the first configuration vectors,
Determining correction values for at least the subset of the first configuration vectors,
Determining a function for transforming the configuration space by evaluating the correction value, and
Determining a calibrated control function by successively executing first the function for transforming the configuration space and thereafter executing the control function.

12. The method according to claim 11, further comprising determining correction values for additional configuration vectors different from the first configuration vectors.

13. The method according to claim 12, wherein the correction values for the additional configuration vectors are determined by interpolation or extrapolation or approximation.

14. The method according to claim 11, further comprising continuing the function for transforming the configuration space beyond a part of the configuration space configured to be occupied by actuators of the kinematics.

15. The method according to claim 11, further comprising
defining a work space as a set of poses realizable by the kinematics when evaluating the control function,
determining a difference between the poses actually assumed by the kinematics, and
taking the difference into account when determining the calibrated control function.

16. The method according to claim 11, wherein transforming the configuration space comprises adding the correction value for the subset of the first configuration vectors to the associated first configuration vector.

17. An arrangement with at least one chip or processor, wherein the arrangement is configured to execute a method for calibrating a kinematics with the steps of:
Defining a predetermined number of first configuration vectors of a configuration space,
Moving the kinematics by applying a control function to the first configuration vectors,
Measuring a pose of the kinematics assumed as a result of moving the kinematics,
Applying an inverse function of the control function to the measured pose for determining second configuration vectors,
Evaluating at least a subset of the first configuration vectors and of the second configuration vectors associated with the subset of the first configuration vectors,
Determining correction values for the subset of the first configuration vectors,
Determining a function for transforming the configuration space by evaluating the correction value, and
Determining a calibrated control function by successively executing first the function for transforming the configuration space and thereafter executing the control function.

18. A computer program stored on a non-transitory computer-readable medium, wherein the computer program enables a data processing device, after the computer program has been loaded into a memory of the data processing device, to perform a method for calibrating a kinematics with the steps of:
Defining a predetermined number of first configuration vectors of a configuration space,
Moving the kinematics by applying a control function to the first configuration vectors,
Measuring a pose of the kinematics assumed as a result of moving the kinematics,
Applying an inverse function of the control function to the measured pose for determining second configuration vectors,
Evaluating at least a subset of the first configuration vectors and of the second configuration vectors associated with the subset of the first configuration vectors,
Determining correction values for the subset of the first configuration vectors,
Determining a function for transforming the configuration space by evaluating the correction value, and
Determining a calibrated control function by successively executing first the function for transforming the configuration space and thereafter executing the control function.

19. Computer readable data stored on a non-transitory computer-readable storage medium, which enable a data processing device, after the computer-readable data have been loaded into a memory of the data processing device, to perform a method for calibrating a kinematics with the steps of:
Defining a predetermined number of first configuration vectors of a configuration space,
Moving the kinematics by applying a control function to the first configuration vectors,
Measuring a pose of the kinematics assumed as a result of moving the kinematics,
Applying an inverse function of the control function to the measured pose for determining second configuration vectors,
Evaluating at least a subset of the first configuration vectors and of the second configuration vectors associated with the subset of the first configuration vectors,
Determining correction values for the subset of the first configuration vectors,
Determining a function for transforming the configuration space by evaluating the correction value, and
Determining a calibrated control function by successively executing first the function for transforming the configuration space and thereafter executing the control function,
wherein the data comprise at least parts of the calibrated control function or at least parts of the correction values.

20. A non-transitory computer-readable storage medium on which computer-readable data or a computer program is stored which enables a data processing device, after the data or the computer program has been loaded into a memory of the data processing device, to execute a method for calibrating a kinematics with the steps of:
Defining a predetermined number of first configuration vectors of a configuration space,
Moving the kinematics by applying a control function to the first configuration vectors,
Measuring a pose of the kinematics assumed as a result of moving the kinematics,
Applying an inverse function of the control function to the measured pose for determining second configuration vectors,
Evaluating at least a subset of the first configuration vectors and of the second configuration vectors associated with the subset of the first configuration vectors,
Determining correction values for the subset of the first configuration vectors,
Determining a function for transforming the configuration space by evaluating the correction value, and
Determining a calibrated control function by successively executing first the function for transforming the configuration space and thereafter executing the control function.
